(19) United States
(12) Patent Application Publication
(10) Pub. No.: US 2003/0195750 A1
(43) Pub. Date: Oct. 16, 2003

(54) Content information as spoken audio

(75) Inventor: Clayton Neil Cowgill, Vancouver, WA (US)

Correspondence Address: MARGER JOHNSON & MCCOLLOM PC, 1030 SW MORRISON STREET, PORTLAND, OR, 97205, US

(73) Assignee: SONICblue, Inc., Santa Clara, CA

(21) Appl. No.: 10/123,955

(22) Filed: Apr. 16, 2002

(51) Int. Cl. G10L 21/00

(52) U.S. Cl. 704/270

(57) ABSTRACT

A portable audio device capable of providing extended information to a user. The portable audio device includes a store of audio data files, a store of extended data associated with the audio data files and an audio converter to convert the audio data files to audio signals and to convert the extended data to audio signals. The converted audio signals are then presented to the user via a speaker.

### BACKGROUND

1. Field

This disclosure relates to portable audio devices, more particularly to presentation of information about audio tracks to users.

2. Background

Portable audio players have many advantages, especially for users who listen to music while active. Digital audio players have even more advantages, since they do not have mechanical parts that skip or break if they are bumped or hit. In addition, digital audio players often have extended information, including track titles, artists, creation dates, etc. The players generally display this information on a small liquid crystal device (LCD), or other display.

However, if the user is active, such as running, biking, or gardening, it may be difficult to see the display. Many digital audio players have a small remote that allows the user to operate the player while the player is positioned where the user cannot see it. For example, a runner may attach the player to the back of the waistband and use the remote to operate the player. In this situation, the user cannot see the extended information, even though being able to see that information may allow the user to skip or select a track and improve their satisfaction with the player. In other situations, the user may be able to reach the main panel of the device but not be in a position to see the display, not requiring a remote, but still having the same problem. In addition to increased user satisfaction, eliminating the need for the user to see the display can also prevent accidents. Therefore, it would be useful for a portable digital audio player to provide the extended information in a manner that does not require the user to look at the display.

### SUMMARY

One embodiment is a portable audio device capable of providing extended information to a user. The portable audio device includes a store of audio data files, a store of extended data associated with the audio data files and an audio converter to convert the audio data files to audio signals and to convert the extended data to audio signals. The converted audio signals are then presented to the user via a speaker. The extended data may be converted to extended audio signals on the player or converted by a host and then transferred to a player.

### BRIEF DESCRIPTION OF THE DRAWINGS

The invention may be best understood by reading the disclosure with reference to the drawings, wherein:

FIG. 1 shows an embodiment of a portable audio device, in accordance with the invention.

FIG. 2 shows an alternative embodiment of a portable audio device connected with a host, in accordance with the invention.

FIG. 3 shows a flowchart of an embodiment of a method to provide extended information as audio signals, in accordance with the invention.

### DETAILED DESCRIPTION OF THE EMBODIMENTS

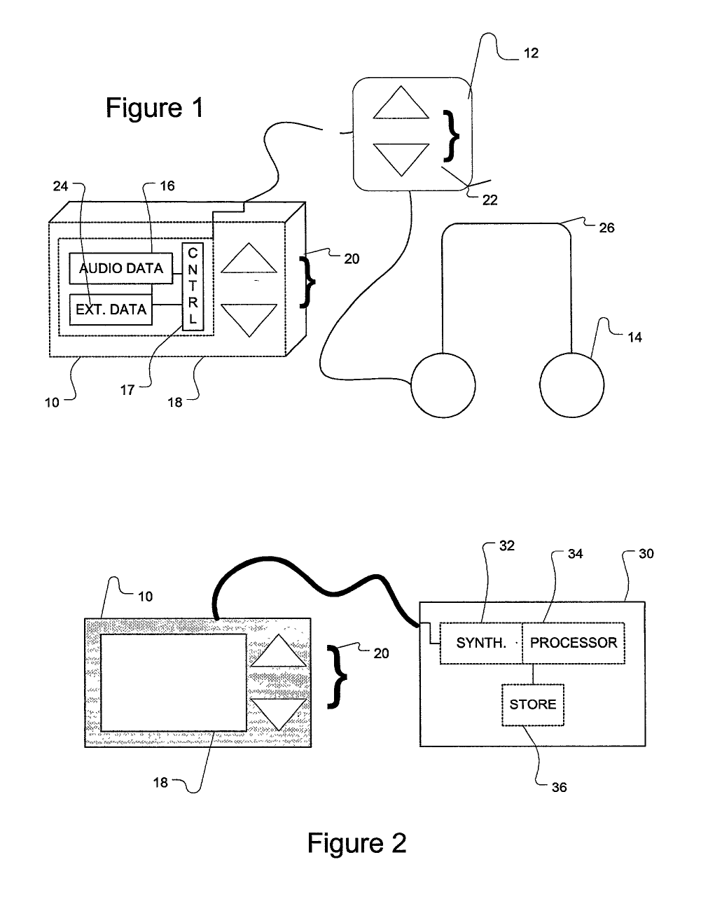

As shown in FIG. 1, one embodiment of a portable audio device includes a player 10, a remote 12, and a speaker 14, embodied here as headphones 26. In this particular embodiment, the player also includes a display 18 and control buttons 20. The control buttons 22 on the remote essentially mimic the functions of the control on the player, but allow the user to access the functions without having to reach the player itself. This may be convenient if the user has clipped the player somewhere that it is not easily accessible, such as the back of the user's waistband, etc.

Generally, the player could be seen as a translator, translating the audio data into audio signals that are then presented to the user. The player, typically through the controller 17, which may be anything from a general-purpose processor, a limited function controller, to an ASIC or dedicated integrated circuit, accesses the audio data files and converts them into audio signals. The audio signals are then sent to a speaker 14, which presents the audio signals to the user.

Inside the player are stored audio data files, such as MP3 (Moving Pictures Experts Group, audio layer 3) music files, audio books, or even files recorded by the user. In this embodiment, these files are stored in audio data store 16. One advantage of digital audio player is their ability to access and present extended data associated with each file. For example, an MP3 track may have extended data associated with it that includes the artists, the CD from which that track came, the play time, the year recorded, etc. It may also include user-generated information, such as a category, genre, play lists in which that track appears, user rating, etc. The extended information may be located in the same store as the audio data files, or separately. The controller 17 would then be responsible to access the extended data store to determine if there is extended data for a particular track and then convert it to display signals.

Typically, this extended information is displayed when that track is to be played, either simultaneously with the beginning of the track or just before. For purposes of discussion, the display or presentation of this extended information will be said to be presented ‘coincident’ with the presentation of the audio signals to the user. Coincident, as used here, means that the extended information is presented in such a manner as to be associated in the user's mind with a particular track. For example, the extended information may be presented just prior to the presentation of the audio from the track, or simultaneously with the beginning of the track or just after the beginning of the track.

As discussed previously, the user may be highly active, participating in athletic activities, such as running, biking or weightlifting, or involved in activities where the user hands are of limited freedom, such as gardening, housework, etc. The user may attach or otherwise rest the player in a position where the user cannot see the display, and may rely upon the use of the optional remote to control the player, rather than having to handle the player. The user can then not see the extended information, limiting the user's ability to decide whether a particular track should be skipped or played until the track has actually started. This is time consuming and many users will likely find this annoying.

Many portable audio devices rely upon a host machine to act as their connection to sources of audio data. For example, most players connect to a user's personal computer or similar machine to access audio files, either from that machine or from a network such as the Internet. The combinations are varied. For example, the user may connect the player to a host to read an audio CD from that machine and transfer the audio data files to the player. During the course of the transfer, the host may access a network to retrieve the extended information regarding that CD, if the information is not also located on the CD. Similarly, the player may merely use the host as a conduit to the network, accessing both the audio data files and the extended information from the network.

An embodiment of a player connected to a host is shown in FIG. 2. Typically, the host will have processing power and capabilities that far exceed that of the player. Therefore, the host could be used to process the extended data into an audio format, producing audio extended data. The audio extended data would then be transferred to the player into the extended data store. During use of the player, the audio extended data could then be presented to the user as audio signals, allowing the user to enjoy the extended information without having to be in a position to see the display on the player.

In the embodiment shown in FIG. 2, the store 36 holds the extended data. As the extended data is typically going to be displayed as text, the extended data may be in text format. The processor 34 takes the extended data, in whatever format, and converts it into a format as required by the speech synthesizer 32. The speech synthesizer then produces the extended data in an audio format, suitable for being played on the player 10. The speech synthesizer may be part of the processor, a separate processor, such as a digital signal processor (DSP), or software instructions running in the processor.

In one embodiment, the player 10 could be a stand alone ‘Internet appliance,’ where all of the necessary functions to connect the player to a network, such as the Internet, and the extended information directly into its stores. In this case, the player would be responsible for converting the extended data into extended audio data, as well as the conversion of the extended audio data into audio signals, as discussed above. In some cases, it may be desirable to put this extended data-to-audio signal conversion functionality in the portable audio device, even if it is not a stand-alone appliance.

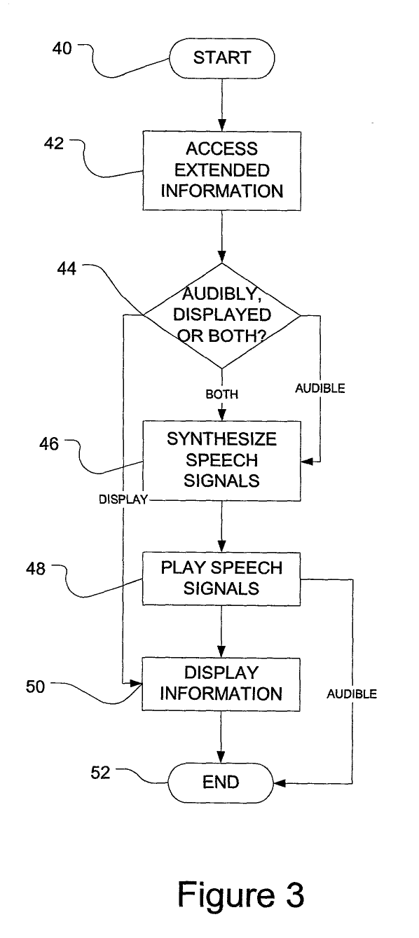

FIG. 3 shows a flowchart of one embodiment of a method to present extended data to a user, in accordance with the invention. The process starts at 40. At 42, the extended information is accessed. This may be done by the player coincident with the playing of a track, or by a host coincident with transferring the track and its associated extended information to the player. At 44, the user may elect to have the extended information displayed, played audibly or both. This is an optional step. The method generally only requires that the extended information be converted to audio signals and presented coincident to the audio file being presented to the user.

Referring back to FIG. 4, if the user selects audible extended information alone or in conjunction with a display, or there is not selection and the player is just configured to produce it, the process moves to 46, at which time the speech signals are synthesized from the extended data. As part of this process, the extended audio data in the form of the speech signals may be transferred to the player and stored in the extended data store, as discussed above. Similarly, at 48, where the speech signals are played, this may include the conversion from audio data to audio signals as discussed above. These conversion processes are performed by a converter, such as the controller 17 of FIG. 1.

If the user selects both forms of extended information, the process will include the extra process of creating and displaying the information at 50. This may involve converting the extended data into display data and then converting the display data into display signals for presentation on the display.

In this manner, the player has access to and may present audible extended information to the user. This eliminates the need for the user to have to look at the display in order to understand the extended information. This will allow the user to receive more enjoyment from the player with increased convenience.

Thus, although there has been described to this point a particular embodiment for a method and apparatus for providing extended information to a user, it is not intended that such specific references be considered as limitations upon the scope of this invention except in-so-far as set forth in the following claims.

What is claimed is:

1. A portable audio device, comprising:
a store of audio data files;
a store of extended data associated with the audio data files;
an audio converter to convert the audio data files to audio signals and to convert the extended data to audio signals; and
a speaker operable to present the audio signals to a user.

2. The device of claim 1, wherein the store of audio data files and the store of extended data are co-located.

3. The device of claim 1, wherein the device further comprise a display converter to convert the extended data to display signals.

4. The device of claim 1, wherein the extended data is in audio data format.

5. The device of claim 1, wherein the device further comprises a speech synthesizer to convert the extended data to audio data format.

6. The device of claim 1, wherein the speaker further comprises headphones.

7. The device of claim 1, wherein the device further comprises a remote control.

8. A method of providing extended data to a user, the method comprising:
converting extended data associated with an audio data file into audio signals; and
producing the audio signals to a user coincident to an audio data file being presented to the user.

9. The method of claim 8, wherein converting extended data further comprises converting the extended data to an audio format, producing extended audio data and converting the audio extended data into audio signals.

10. The method of claim 9, wherein converting the extended data to an audio format is performed on a host.

11. The method of claim 9, wherein converting the extended data to an audio format is performed on a portable audio player.

12. The method of claim 8, wherein the extended data is in an audio format.

13. The method of claim 8, wherein the method further comprises receiving a user input indicating that the user desires extended data to be presented audibly.

14. The method of claim 8, wherein the method further comprises waiting for a user input prior to presenting the audio data file to the user, wherein the user input indicates the status of the presentation of the audio data file.

15. The method of claim 8, wherein the method further comprises:
converting the extended data to a display format, producing extended display data;
converting the extended display data to display signals; and
producing the display signals substantially simultaneous with the audio signals.

16. A portable audio device, comprising:
a means for storing audio data files;
a means for storing extended data associated with the audio data files;
a means for converting the audio data files to audio signals and to convert the extended data to audio signals; and
a means for presenting the audio signals to a user.

17. The device of claim 1, wherein the means for storing audio data files and the means for storing the extended data are co-located.

18. The device of claim 1, wherein the device further comprise a means for converting the extended data to display signals.

19. The device of claim 1, wherein the device further comprises a means for converting the extended data to audio data format.

20. The device of claim 1, wherein the means for presenting further comprises headphones.

21. The device of claim 1, wherein the device further comprises a means for controlling the device remotely.

22. An article containing machine-readable code that, when executed, causes the machine to:
convert extended data associated with an audio data file into audio signals; and
produce the audio signals to a user prior to an audio data file being presented to the user.

23. The article of claim 22 wherein the code that, when executed, causes the machine to convert extended data further comprises code that, when executed, causes the machine to convert the extended data to an audio format, producing extended audio data and convert the audio extended data into audio signals.

24. The article of claim 23, wherein the machine converting the extended data to an audio format is performed further comprises a host.

25. The article of claim 23, wherein the machine converting the extended data to an audio format is a portable audio player.

26. The article of claim 23, wherein the article contains further code that, when executed, causes the machine to receive a user input indicating that the user desires extended data to be presented audibly.

27. The article of claim 23, wherein the article contains further code that, when executed, causes the machine to wait for a user input prior to presenting the audio data file to the user, wherein the user input indicates the status of the presentation of the audio data file.

28. The article of claim 23, wherein the article contains further code that, when executed, causes the machine to:
convert the extended data to a display format, producing extended display data;
convert the extended display data to display signals; and
produce the display signals substantially simultaneous with the audio signals.
